(19) United States
(12) Patent Application Publication
(10) Pub. No.: US 2020/0173398 A1
(43) Pub. Date: Jun. 4, 2020

(54) METHOD AND DEVICE FOR TANK VENTILATION OF A FUEL TANK OF A VEHICLE

(71) Applicant: VOLKSWAGEN AKTIENGESELLSCHAFT, Wolfsburg (DE)

(72) Inventors: Philipp Hackmann, Wolfsburg (DE); Jens Wodausch, Braunschweig (DE); Björn Fröhlich, Gifhorn (DE)

(73) Assignee: VOLKSWAGEN AKTIENGESELLSCHAFT, Wolfsburg (DE)

(21) Appl. No.: 16/701,493

(22) Filed: Dec. 3, 2019

(30) Foreign Application Priority Data
Dec. 3, 2018 (DE) 10 2018 130 676.8

(51) Int. Cl. F02M 25/08; B60K 15/035

(52) U.S. Cl. CPC F02M 25/0836; B60K 15/03504

(57) ABSTRACT

The invention relates to a method and device for tank ventilation of a fuel tank of a vehicle. A first and a second purge air line are to be respectively connected to a fuel vapor collecting device that is arranged downstream from a fuel tank, the first line being connected to an intake manifold and the second line being connected to an air supply system of a supercharging unit. A purging device is additionally provided in the second purge air line. Operating a control device that is designed to at least partially regulate the at least one first purge air flow and/or the second purge air flow ultimately results in venting of the fuel vapor collecting device, with a quantity distribution of an overall purge air stream to the first and second purge air line being controlled by means of the control device and an active control system of a purging device.

### FIELD OF THE INVENTION

The invention relates to a method for tank ventilation of a fuel tank of a vehicle and to a device for tank ventilation of a fuel tank of a vehicle.

### BACKGROUND OF THE INVENTION

In order to operate internal combustion engines, a fuel is used which, before actual use, is stored in a fuel tank, for example. During storage in the fuel tank, evaporation of the fuel, in particular of low-molecular weight hydrocarbons, occurs to varying degrees as a function of an outside temperature and a free liquid surface of the fuel, for example. These evaporation products, commonly referred to as fuel vapors, are usually adsorbed in an activated carbon filter that is disposed in a vent line of the fuel tank. Since the loading capacity of activated carbon filters is limited, they must be purged from time to time with a stream of air. The streams of purge air loaded with fuel vapors and desorbed by the filter must not be discharged untreated into the environment due to legal requirements. One known technique is therefore to feed these purge air streams into the internal combustion engine in order to thus achieve motor-driven combustion of the hydrocarbons contained in the purge air streams.

As the legal requirements for evaporative emissions become more stringent, the demands placed on the tank ventilation system increase as well, which can necessitate higher purge-air flow rates, for example. At the same time, the tension increases with respect to the consumption target to be achieved. Another development with the aim of meeting a low consumption target makes a provision to use the Miller combustion process in small-volume turbocharged internal combustion engines. However, this combination significantly reduces the purge-air volume that can be achieved.

One publicly known solution in this regard is thus represented by tank ventilation systems with two inlet points, the first inlet point behind a throttle valve leading to the intake manifold, whereas the second inlet point ends in front of an exhaust gas turbocharger. In this case, the level of negative pressure in the intake manifold is very large in comparison to the level of negative pressure offered in front of the exhaust gas turbocharger. In order to increase the quantity of purge air introduced upstream from the exhaust gas turbocharger, a Venturi nozzle is used there according to known concepts.

One disadvantage of the concept presented above is that the purge air that is introduced into the intake manifold is dependent on the prevailing level of negative pressure. In addition, the purge gas that is introduced upstream from the exhaust gas turbocharger in combination with the Venturi nozzle only results from the pressure delta over precisely this Venturi nozzle that is used. In this case, the working point of the passive-acting Venturi nozzle is optimal at only one operating point—that is, a maximum volume flow is established only at a specific pressure delta. Furthermore, the use of a Venturi nozzle causes an artificial “leak” in the charge air path, since the drive current is permanently unregulated. The reserve level of the exhaust gas turbocharger drops.

In order to avoid the disadvantages mentioned above, a maximally passive application of the tank ventilation system is selected so that all operating points are covered. However, the compromise calibration leads to losses in the maximum achievable purge-air volume, so that the system is not operated optimally in terms of the proper purge air. In this connection, initial attempts have already been made in the prior art to overcome these disadvantages at least in part.

For instance, printed publication DE 10 2016 225 870 A1 discloses an internal combustion engine with an intake manifold, a fuel tank, and a tank ventilation line that leads from the fuel tank to the intake manifold. It also discloses a method for operating such an internal combustion engine. The internal combustion engine comprises at least one intake manifold leading through a compressor of an exhaust gas turbocharger to a combustion chamber, at least one fuel tank, and a tank ventilation line. The tank ventilation line leads from the fuel tank to the compressor. An adsorption filter, particularly an activated carbon container, is arranged in the tank ventilation line between the fuel tank and the compressor. An electrically driven purge air pump for conveying purge air is also arranged in the tank ventilation line. The purge air pump is arranged particularly downstream from the adsorption filter. The purge air pump is arranged such that purge air can be conveyed at least partially in the direction of a compressor wheel of the compressor with the purge air pump.

Therefore, this publication does not disclose operation of a control device that is designed to at least partially regulate at least one first purge air stream and/or one second purge air stream, and that a fuel vapor collecting device is then ventilated via the at least one first purge air line and/or via the second purge air line, with a quantity distribution of an overall purge air stream that is composed of the at least one first and the at least second purge air stream to the first and second purge air line being controlled by means of the control device and an active control system of a purging device.

It is the object of the invention to provide a method and a device for tank ventilation of a fuel tank of a vehicle with which optimal system management in terms of demand-based ventilation is ensured.

### SUMMARY OF THE INVENTION

In a preferred embodiment of the invention, a provision is made that a method for tank ventilation of a fuel tank of a vehicle is provided. Such a method comprises the following steps: Connecting a fuel vapor collecting device that is arranged downstream from a fuel tank to an intake manifold of an internal combustion engine by means of at least one first purge air line such that at least one first purge air stream can be directed downstream from the fuel vapor collection device toward the internal combustion engine; connecting the fuel vapor collection device that is arranged downstream from a fuel tank to an air supply system from a supercharging unit via a second purge air line, so that a second purge air stream can be directed downstream from the fuel vapor collecting device in the direction of the supercharging unit and then into the internal combustion engine, with a purging device being provided in the second purge air line, and with the method further comprising the following additional steps: Operation of a control device that is designed to at least partially regulate at least one first purge air stream and/or one second purge air stream; ventilating the fuel vapor collecting device via the at least one first purge air line and/or via the second purge air line, with a quantity distribution of an overall purge air stream that is composed of the at least one first and the at least second purge air stream to the first and second purge air line being controlled by means of the control device and an active control system of the purging device.

In this way, it is possible to provide optimal system management in terms of demand-based ventilation. The fully variable controllability of the active purging device and control device makes highly accurate metering of the supplied tank ventilation gases possible and thus effectuates a slight influence on the mixture formation and a reduction in raw emissions. Instead of a single setting that is then statically provided for a wide variety of operating conditions, it is thus possible to implement a demand-based control by means of the method presented. For the proposed combination of the purging device and the components of the control device, the control device can also all of the interfaces and superordinate control elements that are required for this, such as a control unit, for example, that appropriately implements the proposed method steps. This makes an engine operating point-independent supply of tank ventilation gases and, consequently, an increase in the maximum possible purge-air volume possible. High dosability of the tank ventilation gases is thus also possible during the initial notching-up phase, so that a slight influencing of the mixture formation is achieved. In particular, the proposed method is intended for use in all gasoline engines of vehicles. The supercharging unit can be an exhaust gas turbocharger, for example, and in particular a compressor of such an exhaust gas turbocharger.

In a preferred embodiment of the invention, a provision is made that a device for tank ventilation of a fuel tank of a vehicle is provided. Such a device comprises at least one first purge air line that is designed to be arranged between a fuel vapor collecting device that is arranged downstream from a fuel tank and an intake manifold of an internal combustion engine, so that at least a first purge air stream can be directed downstream from the fuel vapor collecting device in the direction of an internal combustion engine, and a second purge air line that is designed to be arranged between a fuel vapor collecting device that is located downstream from a fuel tank and an air supply system of a supercharging unit, so that a second purge air stream can be directed downstream from the fuel vapor collecting device in the direction of the supercharging unit and subsequently into the internal combustion engine, wherein a purging device is arranged in the second purge air line, wherein a control device is additionally provided that is designed to regulate the at least one first purge air stream and/or the second purge air stream at least partially, so that a ventilation of the fuel vapor collecting device via the at least one first purge air line and/or via the second purge air line can be controlled by means of the control device and an active control of the purging device, and wherein a quantity distribution of an overall purge air stream that is composed of the at least one first and the second purge air stream to the first and second purge air lines is controllable. To the extent practicable, the advantages mentioned above apply in like manner to the device presented. The supercharging unit can be an exhaust gas turbocharger, for example, and in particular a compressor of such an exhaust gas turbocharger.

Other preferred embodiments of the invention will become apparent from the remaining features, which are indicated in the subclaims.

For instance, a provision is made in another preferred embodiment of the invention that the control device comprises at least one control valve. Targeted dosing of the purge air stream can thus be achieved even better and controlled even better in combination with the purging device. Such a control valve can be present in both analog and digitally switchable form. A mixed form is also conceivable. For example, a control valve in this sense can be understood as being a switching device by means of which both discrete states can be realized (for example, open and closed) or continuous configuration of a valve can be performed. A valve opening can then be freely adjustable, for example between 0-100%.

In addition, a provision is made in another preferred embodiment of the invention that the control device comprises at least two control valves, a first control valve being arranged between purging device and exhaust gas turbocharger and at least one second control valve being arranged between fuel vapor collecting device and intake manifold. The various purge air lines can also be referred to as respective purge paths. The proposed positioning of the control valves as respective components of a superordinate control device allows optimized operation of the tank ventilation. For example, demand-driven control of the tank ventilation can thus be achieved with at least two paths and an active purging device.

It is thus possible, in particular, to apply a respective optimum purge-air volume by means of the presented method in which an optimal distribution to the purge paths provided is made possible for the respective operating state. These two control valves can also be present in both analog and digitally switchable form. A mixed form is also conceivable. In particular, an inlet point can be provided immediately in front of a supercharging unit, particularly in front of the compressor of an exhaust gas turbocharger. Instead of the compressor in its basic version, another compressor/compression element of any supercharging unit could be provided. Such a charging unit could also be instantiated by the compressor wheel of an exhaust gas turbocharger, for example, or of an electrically driven compressor or a compressor as well as any mixed form of the aforementioned components. In terms of the method presented, an exhaust gas turbocharger can be a conventional exhaust gas turbocharger any other supercharging unit.

A provision is also made in another preferred embodiment of the invention that the purging device comprises at least one purge air pump. A pump can be controlled in a particularly targeted and hence need-based manner in combination with the control device, so that the aforementioned advantages can be implemented even better.

Moreover, a provision is made in another preferred embodiment of the invention that the at least one purge air pump can be driven electrically. Electrical operation not only makes possible the uniquely targeted control in terms of optimal achievement of the aforementioned advantages, but also allows for an especially simple and reliable combination with the proposed control device.

Furthermore, in another preferred embodiment of the invention, a provision is made that the control device comprises at least one pressure and temperature sensor that is arranged between purging device and air supply system or comprises at least two pressure and temperature sensors, with a pressure and temperature sensor being arranged in a connecting line between fuel tank and fuel vapor collecting device, and with a respective pressure and temperature sensor being arranged between purging device and air supply system. The information to be additionally obtained, which make corresponding inferences to be drawn about a respective operating state, thus serve the function of ensuring an even more reliable and even more optimal ventilation of the fuel tank and/or of the fuel vapor collecting device that is arranged downstream from the tank.

As a higher-level instance, the control device is appropriately configured using designated interfaces and work routines, for example in the form of user-defined instruction protocols or generally in the form of at least partially preprogrammed control modules, to implement the proposed combination and processing of the various associated information sources for an optimal ventilation strategy at any point in time.

Instead of the respective pressure and temperature sensors, pressure sensors and/or temperature sensors that stand alone by themselves could also be provided. In other words, one possible design variant could also make a provision that stand-alone pressure sensors or two individual sensors are provided, one for pressure and one for temperature.

Any technical assembly that also provides measurement results in a comparable dimension to the aforementioned sensors may also be provided in variants.

In another preferred embodiment of the invention, a provision is made that the control device comprises a third control valve, said third control valve being arranged in the connecting line between fuel tank and fuel vapor collecting device. Also, this third control valve is thus another component of a superordinate control device, so that the aforementioned advantages can be implemented even better.

In another preferred embodiment of the invention, a provision is also made that the quantity distribution of an overall purge air stream takes place as a function of load determination. In dependence upon a state of the overall system, a corresponding distribution of the purge-air volumes on the various paths can be performed in order to enable optimal system management.

Load determination is to be regarded as part of a process in which a loading state of the fuel vapor collecting device or an averaged hydrocarbon concentration of the purge gas/purge air is determined.

In another preferred embodiment of the invention, a provision is made that the quantity distribution of the overall purge air stream occurs as a function of a load determination and of a pressure condition in the intake manifold and/or of a pressure condition at or in front of the inlet point of the supercharging unit, particularly an inlet point at a compressor of the exhaust gas turbocharger. For example, after the engine has been started, tank ventilation can be initially operated exclusively via the second purge air line. The purging of the tank ventilation gases is thus performed by the active purging device. Subsequently, a load can be determined. On the basis of this information and the existing pressure condition in the intake manifold and a pressure condition at the inlet point in front of a supercharging unit (compressor, for example) as well as any additional signals that might exist (from the aforementioned sensors or in the form of other environmental information, for example), the purge-air volumes to be conveyed can then be distributed to the two purge air paths, thus enabling optimal system management. As such, a fully variable distribution of the quantities to the respective paths is also conceivable.

Furthermore, in another preferred embodiment of the invention, a provision is made that, before the quantity distribution of the overall purge air stream, an at least partial venting operation on the part of the fuel vapor collecting device is always controlled exclusively via the second purge air line. The abovementioned advantages are thus rendered even more attainable.

In addition, a provision is made in another preferred embodiment of the invention that the fuel vapor collecting device comprises at least one activated carbon filter element. For example, the fuel vapor collecting device can be provided in the form of a container in which the activated carbon filter elements are appropriately held available. The occurring fuel vapors that flow downstream from the fuel tank in the direction of the activated carbon filter elements can thus be kept at bay at least in part, so that an excess amount of vapors can be kept low. Optimal operation can also be ensured in this way, since the amounts of vapors that occur do not exceed a critical mass. The term “critical mass” can be understood here in connection with the amount of gaseous hydrocarbons that are still compatible with the current engine operation. In this context, the venting of the fuel tank is equivalent to the venting of the fuel vapor collecting device, since a causal chain of effects of the vapors that occur exists here.

Moreover, a provision is made in another preferred embodiment of the invention that the purging device that is provided in the proposed device comprises at least one purge air pump. The aforementioned advantages for the method apply to the extent applicable to this variant of the proposed device as well.

Finally, in another preferred embodiment of the invention, a provision is made that the control device has at least two control valves, with a first control valve being arranged between purging device and air supply system and at least one second control valve being arranged between fuel vapor collecting device and intake manifold, and with the control device comprising at least one pressure and temperature sensor that is arranged between purging device and air supply system or at least two pressure and temperature sensors, with one pressure and temperature sensor being arranged between purging device and air supply system and a second pressure/temperature sensor being arranged downstream from the tank, the latter being arranged either in front of or behind the fuel vapor collecting device. The aforementioned advantages for the method apply to the extent applicable to this variant of the proposed device as well.

Instead of a pressure and temperature sensor, it is also possible for individual pressure sensors and temperature sensors to be provided. In general, instead of sensors, comparable technical components can also be provided that can also provide the desired measurement results for this purpose.

Unless otherwise stated in the individual case, the various embodiments of the invention mentioned in this application can be advantageously combined with one another.

### BRIEF DESCRIPTION OF THE DRAWINGS

The invention will be explained below in exemplary embodiments with reference to the accompanying drawing. In the drawing:

FIG. 1 shows a block diagram of a device for tank ventilation of a fuel tank of a vehicle;

FIG. 2 shows a flowchart of the process sequence of the method according to the invention for tank ventilation of a fuel tank of a vehicle; and

FIG. 3 shows another flowchart of the process sequence of the method according to the invention for tank ventilation of a fuel tank of a vehicle.

### DETAILED DESCRIPTION OF THE INVENTION

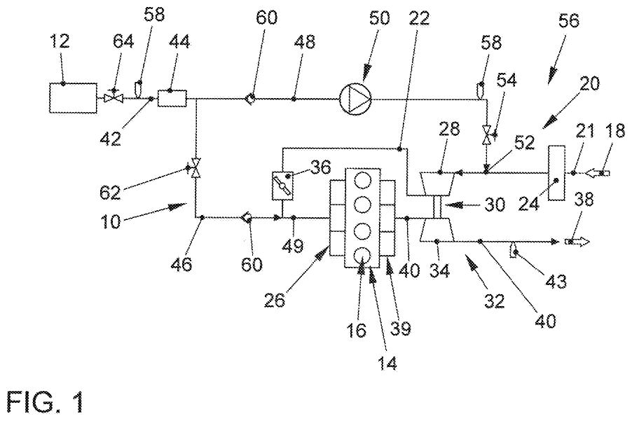

FIG. 1 shows a block diagram of a device 10 for tank ventilation of a fuel tank 12 of a vehicle that is not shown in an installed state. In other words, selected components of the vehicle are thus identifiable, so that the device 10 is illustrated schematically as being appropriately coupled with or connected to these components. As an additional component of the vehicle, an internal combustion engine 14 can also be seen which can be operated with fuel, for example gasoline, from the fuel tank 12. As stated, the fuel is stored in the fuel tank 12, it being possible for the fuel tank 12 to be refueled via a filler neck (not shown in further detail).

During operation, the fuel is then supplied from the fuel tank 12 via a fuel line (also not shown in further detail) by means of a fuel pump to the internal combustion engine 14, where it is distributed by means of an injection system (also not shown in further detail) to the cylinders 16 of the engine 14. Injection valves of the injection system that are not shown in detail inject the fuel into a combustion chamber before it is fed to the cylinders 16 or—in the case of direct-injection engines—directly into the cylinder 16.

The internal combustion engine 14 thus comprises at least one, here four cylinders 16, for example, and can be a (self-igniting) diesel engine or a (spark-ignited) gasoline engine. In the present example, it is a gasoline engine that is ignited by means of spark plugs.

The combustion air 18 is supplied to the engine 14 by an air supply system 20 as another component of the vehicle that draws the air 18 from the environment and feeds it into the engine 14 via an intake air line 21, an air filter 24, and an air manifold 26, which distributes the air to the cylinders 16. In the depicted example, the combustion air 18 is compressed by a compressor 28 of an exhaust gas turbocharger 30 in order to enable the engine 14 to be operated with increased boost pressure and thus with greater power output. The compressor 28 is driven by a turbine 34 that is disposed in an exhaust system 32 via a shaft. An adjustable throttle valve 36 by means of which the cylinder filling can be controlled or regulated is arranged in the pressure pipe 22 downstream from the compressor 28. Exhaust gas 38 from the engine 14 is ultimately discharged via an exhaust manifold 39 of the exhaust system 32 and then into an exhaust duct 40 that is provided in the exhaust system 32 to the environment. A lambda probe 43 that can be generally used in addition to control purposes is additionally arranged behind the turbine 34 in the exhaust duct 40. The exhaust duct 40 can ultimately lead to an exhaust system (not shown in further detail) in which the exhaust gases 38 can be treated appropriately before being emitted into the environment. The previously mentioned turbine 34 of the exhaust gas turbocharger 30 is arranged in the exhaust duct 40, so that the exhaust gas 38 drives the turbine 34 and thus the compressor 28 while withdrawing kinetic energy.

From the illustrated fuel tank 12, fuel vapors pass via a connecting line 42 into a fuel vapor collecting device 44, which can comprise one or more activated carbon elements, for example. Starting from this fuel vapor collecting device 44, two purge air lines 46, 48 are shown, these purge air lines 46, 48 being routed together over a distance directly against the fuel vapor collecting device 44. As an example, the fuel vapor collecting device could be installed at least partially in the rear carriage.

The first purge air line 46 connects the fuel vapor collecting device 44 to an intake manifold 49 and finally via the air manifold 26 to the engine 14, so that at least a first stream of purge air can be directed downstream from the fuel vapor collecting device 44 in the direction of the internal combustion engine 14. The second purge air line 48 thus connects the fuel vapor collecting device 44 to the air supply system 20, so that a second purge air stream can be directed downstream from the fuel vapor collecting device 44 in the direction of the exhaust gas turbocharger 30 and subsequently into the internal combustion engine 14. A purging device 50—which can be an electrically operable purge air pump, for example—is provided in the second purge air line 46. In other words, it is an active purging device 50 in the sense that it is a purging device 50 that can be activated in a user-defined manner. This purging device 50 can be arranged, for example, either at the front end or in the front portion of the vehicle or at the rear end or in the rear portion of the vehicle.

Furthermore, a first control valve 54, which is part of a superordinate control device 56, is shown shortly before the inlet point 52 into the air supply system 20. A pressure and temperature sensor 58 is also arranged between the purging device 50 and the first control valve 54. A check valve 60 is also shown between the purging device 50 and the fuel vapor collecting device 44. A check valve 60 is also arranged in the first purge air line 46. In addition, a second control valve 62, which is also part of the control device 56, is arranged between the intake manifold 49 and the fuel vapor collecting device 44. The control device 56 can optionally also comprise a third control valve 64. This third control valve 64 is arranged in the connecting line 42. In addition, a pressure and temperature sensor 58 is also arranged in the connecting line 42, this pressure and temperature sensor 58 being arranged between the control valve 64 and the fuel vapor collecting device 44, for example downstream behind the fuel vapor collecting device 44. While this pressure and temperature sensor 58 can further support the presented method in terms of efficient application, it is only to be regarded as optional for a basic variant of the method. The pressure and temperature sensors 58 shown, both in the connecting line 42 and in the second purge air line 48, also belong to the control device 56.

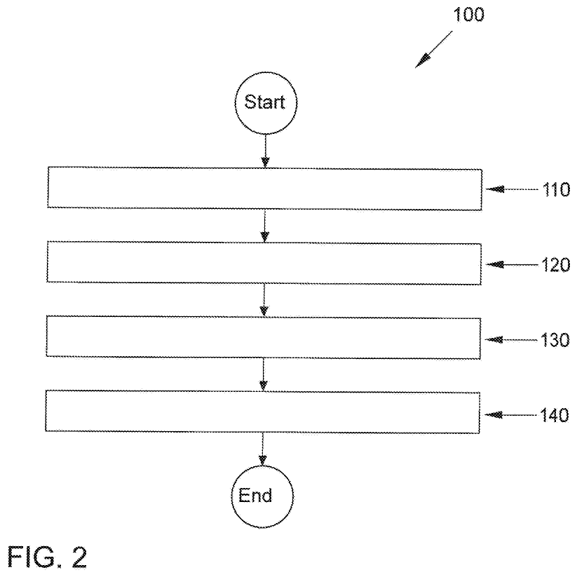

FIG. 2 shows a flowchart 100 of the process sequence of the method according to the invention for tank ventilation of a fuel tank 12 of a vehicle. In a first step 110, a fuel vapor collecting device 44 that is arranged downstream from a fuel tank 12 is connected to an intake manifold 49 of an internal combustion engine 14 by means of at least one first purge air line 46, so that at least a first purge air stream can be directed downstream from the fuel vapor collecting device 44 in the direction of the internal combustion engine 14.

In a second step 120, the fuel vapor collecting device 44 that is arranged downstream from a fuel tank 12 is connected to an air supply system 20 of an exhaust gas turbocharger 30 by means of a second purge air line 48, so that a second purge air stream can be directed downstream from the fuel vapor collecting device 44 in the direction of the exhaust gas turbocharger 30 and subsequently into the internal combustion engine 14, a purging device 50 being provided in the second purge air line 48.

In a third step 130, a control device 56 is operated which is designed to at least partially regulate the at least one first purge air flow and/or the second purge air flow. In this context, the term “operate” can be interpreted broadly and thus also includes an initial startup or a general starting routine, so that the control device 56 is switched or brought into a ready-to-operate mode.

In a fourth step 140, the fuel vapor collecting device 44 is vented via the at least one first purge air line 46 and/or via the second purge air line 48, with by means of the control device 56 and an active control of the purging device 50, a quantity distribution of an overall purge air stream composed of at least one first and second purge air stream to the first and second purge air line 46, 48 being controlled by means of the control device 56 and an active controlling of the purging device 50.

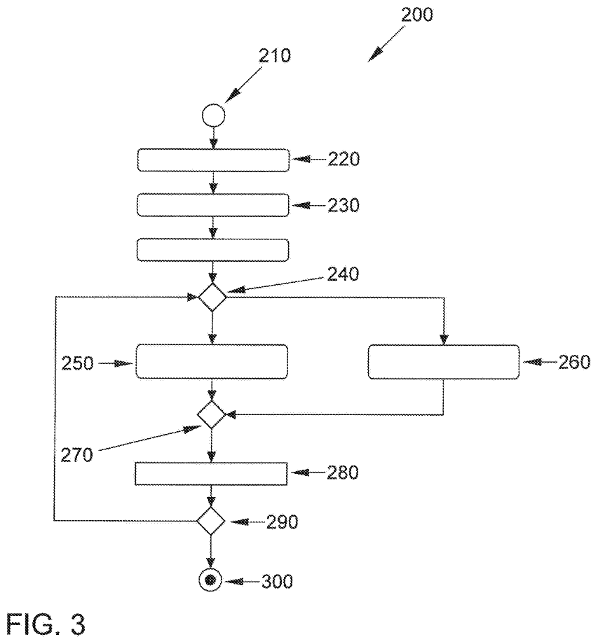

FIG. 3 shows another flowchart 200 of the process sequence of the method according to the invention for tank ventilation of a fuel tank 12 of a vehicle. This flowchart 200 is only a very rough representation of one possible design variant and does not include, for example, the simultaneous purging via both paths, although this would be quite possible in a manner not shown and in another embodiment. After successful enablement of tank ventilation 210 during engine operation, purging via the second purge air line 48 can be prepared in a first process instruction 220 (activation of path II). In a second process instruction 230, a load determination is carried out. This is followed by a first decision query 240, with the current pressure condition in the intake manifold 49 being determined and evaluated here. If the negative pressure in the intake manifold 49 is sufficient for the purpose of setting a desired purge air mass flow, the third process instruction 250, which provides for purging via the first purge air line 46, follows accordingly. On the other hand, if the purge air mass flow that can be achieved via the first purge air line is considered insufficient based on the prevailing pressure level in the intake manifold 49, the fourth process instruction 260, which provides for purging via the second purge air line 48, follows automatically and immediately. Both process instructions 250, 260 each lead to a first control routine 270, in which the corresponding upstream purges are checked for execution. Subsequently, in the fifth process instruction 280, the load condition after purging is once again checked for plausibility and, in conjunction with a second decision query 290, it is determined to what extent purging mode is still required. If so, the steps in the present activity diagram are repeated appropriately starting from the first decision query 240. If not, stop purging mode 300 is executed, and the process is regarded as having been concluded.

### LIST OF REFERENCE SYMBOLS

10 device
12 fuel tank
14 combustion engine
16 cylinder
18 combustion air
20 air supply system
21 intake air line
22 pressure pipe
24 air filter
26 air manifold
28 compressor
30 supercharging unit
32 exhaust system
34 turbine
36 throttle valve
38 exhaust gas
40 exhaust duct
42 connection line
43 lambda sensor
44 fuel vapor collecting device
46 first purge air line
48 second purge air line
49 intake manifold
50 purging device
52 inlet point
54 first control valve
56 control device
58 pressure and temperature sensor
60 check valve
62 second control valve
64 third control valve
100 flowchart
110 first step
120 second step
130 third step
140 fourth step
200 additional flowchart
210 enabling of tank ventilation
220 first process instruction
230 second process instruction
240 first decision query
250 third process instruction
260 fourth process instruction
270 first control routine
280 fifth process instruction
290 second decision query
300 stop purging mode

1. A method for tank ventilation of a fuel tank of a vehicle, comprising the following steps:
connecting a fuel vapor collecting device that is arranged downstream from the fuel tank to an intake manifold of an internal combustion engine by means of at least one first purge air line, so that at least a first purge air stream can be directed downstream from the fuel vapor collecting device in the direction of the internal combustion engine;
connecting the fuel vapor collecting device that is arranged downstream from a fuel tank to an air supply system of an exhaust gas turbocharger by means of a second purge air line, so that a second purge air stream can be directed downstream from the fuel vapor collecting device in the direction of the exhaust gas turbocharger and subsequently into the internal combustion engine, a purging device being provided in the second purge air line,
operating a control device that is designed to at least partially regulate the at least one first purge air flow and/or the second purge air flow; and
venting the fuel vapor collecting device via the at least one first purge air line and/or via the second purge air line, with by means of the control device and an active control of the purging device, a quantity distribution of an overall purge air stream composed of at least one first and second purge air stream to the first and second purge air line being controlled by means of the control device and an active controlling of the purging device.

2. The method as set forth in claim 1, wherein the control device comprises at least one control valve.

3. The method as set forth in claim 1, wherein the control device comprises at least two control valves, a first control valve being arranged between the purging device and the exhaust gas turbocharger, and at least one second control valve being arranged between the fuel vapor collecting device and the intake manifold.

4. The method as set forth in claim 1, wherein the purging device comprises at least one purge air pump.

5. The method as set forth in claim 4, wherein the at least one purge air pump is electrically operable.

6. The method as set forth in claim 1, wherein the control device comprises at least one pressure and temperature sensor that is arranged between the purging device and the air supply system or comprises at least two pressure and temperature sensors, with a pressure and temperature sensor being arranged in a connecting line between the fuel tank and the fuel vapor collecting device, and with a respective pressure and temperature sensor being arranged between the purging device and the air supply system.

7. The method as set forth in claim 1, wherein the control device comprises a third control valve, the third control valve being arranged in the connecting line between the fuel tank and the fuel vapor collecting device.

8. The method as set forth in claim 1, wherein the quantity distribution of an overall purge air stream occurs as a function of a load determination.

9. The method as set forth in claim 1, wherein the quantity distribution of the overall purge air stream occurs as a function of a load determination and of a pressure condition in the intake manifold and/or of a pressure condition at in front of the inlet point of the supercharging unit, particularly an inlet point at a compressor of the exhaust gas turbocharger.

10. The method as set forth in claim 1, wherein, before the quantity distribution of the overall purge air stream, an at least partial venting operation on the part of the fuel vapor collecting device is always controlled exclusively via the second purge air line.

11. The method as set forth in claim 1, wherein the fuel vapor collecting device comprises at least one activated carbon filter element.

12. A device for tank ventilation of a fuel tank of a vehicle, comprising:
at least one first purge air line that is designed to be arranged between a fuel vapor collecting device that is arranged downstream from a fuel tank and an intake manifold of an internal combustion engine, so that at least a first purge air stream can be directed downstream from the fuel vapor collecting device in the direction of an internal combustion engine, and
a second purge air line that is designed to be arranged between a fuel vapor collecting device that is located downstream from a fuel tank and an air supply system of a supercharging unit, so that a second purge air stream can be directed downstream from the fuel vapor collecting device in the direction of the supercharging unit and subsequently into the internal combustion engine, a purging device being arranged in the second purge air line,
a control device designed to regulate the at least one first purge air stream and/or the second purge air stream at least partially, so that a ventilation of the fuel vapor collecting device via the at least one first purge air line and/or via the second purge air line can be controlled by means of the control device and an active control of the purging device, a quantity distribution of an overall purge air stream that is composed of the at least one first and the second purge air stream to the first and second purge air lines being controllable.

13. The device as set forth in claim 12, wherein the purging device comprises at least one purge air pump.

14. The device as set forth in claim 12,
wherein the control device has at least two control valves, with a first control valve being arranged between the purging device and the air supply system, and at least one second control valve being arranged between the fuel vapor collecting device and the intake manifold,
the control device further comprising at least one pressure and temperature sensor that is arranged between the purging device and the air supply system or at least two pressure and temperature sensors, with one pressure and temperature sensor being arranged between the purging device and the air supply system, and a second pressure/temperature sensor being arranged downstream from the tank, the latter being arranged either in front of or behind the fuel vapor collecting device.
